(19) United States
(12) Patent Application Publication
(10) Pub. No.: US 2013/0041751 A1
(43) Pub. Date: Feb. 14, 2013

(54) ONLINE ADVERTISEMENT RELAYING SYSTEM AND ONLINE ADVERTISEMENT RELAYING METHOD USING SAME

(71) Applicant: Kwang Soon Park, Gyeonggi-do (KR)

(72) Inventor: Kwang Soon Park, Gyeonggi-do (KR)

(21) Appl. No.: 13/639,867

(22) PCT Filed: Apr. 6, 2011
(86) PCT No.: PCT/KR2011/002403

§ 371 Date: Oct. 8, 2012

(30) Foreign Application Priority Data
Apr. 7, 2010 (KR) 10-2010-0031946

(51) Int. Cl. G06Q 30/02

(52) U.S. Cl. 705/14.56; 705/14.55

(57) ABSTRACT

There are provided a system and a method for intermediating an on-line advertisement. The system for intermediating an on-line advertisement, which provides an on-line advertisement intermediation site to a plurality of terminals connected through a communication network, includes: a database where a plurality of on-line advertisements is stored; and an advertisement server that provides an advertisement list of the on-line advertisements stored in the database to the terminals, that when receiving a request for seeing some of the advertisements included in the advertisement list from users, displays the contents of the advertisements on the terminals, ascertains whether the users have seen the advertisements, and stores lists of the advertisements that the users have seen, to user accounts, respectively, creates an advertising message including at least one of the advertisements included in the lists of the advertisements stored in the user accounts and transmits the advertising message to the terminals of another user, in accordance with an instruction from the user. It is possible to achieve a high effect of transmitting an advertisement, because consumers can distribute advertisements by themselves.

### BACKGROUND OF THE INVENTION

1. Field of the Invention

The present invention relates to a system and a method for intermediating on-line advertisements, and in more detail, a system and a method for intermediating on-line advertisements which allow free registration of on-line advertisements through a communication network, and allow a plurality of users to see and distribute the registered on-line advertisements.

2. Description of the Related Art

Recently, on-line advertisements are greatly increasing, with diversification of the advertisement media and rapid development of the Internet. The on-line advertisement market is expected to continuously expand, because the on-line advertisement has the advantage that not only the cost is smaller than advertisement through other media, but specified marketing for specific classes is possible.

However, there is a problem in that the common internet users have to follow complicated procedures for registering an on-line advertisement and individuals or medium and small companies have to pay for a little burdensome cost. Further, there is another problem in that not only there is small choice for the on-line advertisement, which can be uploaded even by the Internet users who want an advertisement commission, but it is necessary to follow complicated procedures for searching, choosing, and registering an on-line advertisement.

On the other hand, recently, advertisements are implemented in a way that transmits advertisements to individuals through an email or a text message for effective advertisement, and in the advertisements, it was necessary to make an effort to put contents for applying to various events in the advertising messages, in order to make the consumers more concentrate on the advertisements. However, those advertisements not only had difficulty in attracting the consumers' attention, but had to secure individual information such as the email addresses or the mobile terminal numbers of many users, and it was difficult to ensure the individual information, there were some illegal acts such as leakage of individual information.

Further, since the consumers are little interested in the advertisements even though advertising messages are transmitted to the individuals in the way described above, there was a problem in that it is difficult to substantially transmit the advertisement contents to the consumers.

### SUMMARY OF THE INVENTION

Therefore, the present invention has been made in an effort to provide system and method for intermediating an on-line advertisement, which provide a user interface, which simplifies registration of an advertisement, and integrates and provides a plurality of on-line advertisements to a database.

Further, the present invention provides system and method for intermediating an on-line advertisement that can transmit an advertisement to a plurality of consumers by allowing the consumers to distribute the on-line advertisement by themselves.

Further, the present invention provides system and method for intermediating an on-line advertisement that allow consumers to concentrate on an advertisement by allowing any consumer to make a profit from an advertisement rate.

According to an aspect of the present invention, a system for intermediating an on-line advertisement, which provides an on-line advertisement intermediation site to a plurality of terminals connected through a communication network, includes: a database where a plurality of on-line advertisements is stored; and an advertisement server that provides an advertisement list of the on-line advertisements stored in the database to the terminals, that when receiving a request for seeing some of the advertisements included in the advertisement list from users, displays the contents of the advertisements on the terminals, ascertains whether the users have seen the advertisements, and stores lists of the advertisements that the users have seen, to user accounts, respectively, creates an advertising message including at least one of the advertisements included in the lists of the advertisements stored in the user accounts and transmits the advertising message to the terminals of another user, in accordance with an instruction from the user.

The advertisement server may provide a user interface for receiving on-line advertisement registration information from the terminal and registering the on-line advertisement to the terminal, register the advertisement on the advertisement list by processing the on-line advertisement registration information inputted from the terminal and determining whether to register the on-line advertisement, and store the on-line advertisement registration information in the database.

Further, the advertisement server, when receiving a request for seeing any one advertisement in the advertisement list of the on-line advertisements stored in the database, from the terminal, may output the advertisement with predetermined information including a text or audio data to the terminal, and considers that a user has seen the advertisement, include the advertisement into the list of the seen advertisements, and store the advertisement in the user account, only when information inputted from the terminal coincides with the predetermined information.

The advertisement server may provide the terminal with an application for ascertaining whether a user has seen an advertisement by photographing the face or the eyes of the user of the terminal while the advertisement is displayed on the terminal, and when receiving a request for seeing any one advertisement in the advertisement list of the on-line advertisement stored in the database from the terminal, may output the advertisement to be displayed on the terminal, receive the result of executing the application from the terminal, and then include the advertisement into the list of the seen advertisements and store the advertisement in the user account, only when it is ascertained that the user has seen the advertisement.

The advertising message may include a hypertext or a hyperimage for connecting with an URL address of a webpage including the information on the user who transmits the advertising message, advertisement information included in the advertising message, and the contents of the advertisement included in the advertising message.

The advertising message may be transmitted by at least one of an email, a text message of a mobile communication terminal, and a message of an instant messenger program.

Further, the advertisement server may calculate the unit cost of the advertisement included in the advertising message as an advertisement rate to be paid to a user, when the advertising message is transmitted, the terminal of another use to which the advertising message is transmitted requests for transmitting a webpage including the contents of the transmitted advertisement in the advertising message, information inputted from the terminal of another user coincides with predetermined information including a text or audio data included in the contents of the advertisement after the terminal of the another user to which the advertising message is transmitted requests for transmitting the webpage including the contents of the transmitted advertisement in the advertising message. The advertisement server, when displaying the information on the unit cost of an advertisement after a user sees the advertisement on the terminal, may display any one of two or more different unit costs of an advertisement that is set to have different ratios of exposure frequency on the terminal, and calculate an advertisement rate on the basis of the unit cost of an advertisement displayed on the terminal, when calculating the advertisement rate according to the result of transmitting an advertising message to the terminal of another user from the user of the advertisement.

Further, the two or more different unit costs of an advertisement may be set to have an exposure frequency with a ratio that increases with a decrease of the unit cost of an advertisement.

According to another aspect of the present invention, a storage medium where an advertisement messenger program stores on-line advertisements registered through an on-line advertisement intermediation site in a database and operates with an advertisement server that allows the on-line advertisements stored in the database to be distributed and seen to a plurality of users through a communication network, by displaying an advertisement list of the stored on-line advertisement on the on-line advertisement intermediation site, in which the advertisement messenger program, when being installed in a terminal, (A) provides a list of friends of a user of the terminal and a list of advertisements that the user of the terminal has seen, in accordance with the contents stored in a user account in the advertisement server by connecting with the advertisement server when the user of the terminal logs in, (B) when an advertising message transmitted by another user is received by the advertisement server, displays the received advertising message to the terminal, and (C) when the user of the terminal selects at least one advertisement from the list of advertisement that the user has seen, selects at least one friend from the friend list, and gives an instruction of transmitting an advertising message, notifies the advertisement server of the selected information.

Further, the advertisement messenger program may provide a record of transmitting/receiving an advertising messenger of the user of the terminal and provides the result of calculating an advertisement rate that is paid to the user of the terminal.

Further, the advertisement messenger program may display the contents of an advertisement when the user of the terminal requests to see the advertisement included in the received advertising message to the terminal, receive the information for ascertaining whether the user has seen the displayed contents of the advertisement and provides the information to the advertisement server, and include the advertisement into the user account of the user of the terminal and into the list of advertisements that the user of the terminal has seen, when the input information coincides with information that is stored in advance for the advertisement in the advertisement server.

Further, the advertisement messenger program may display the contents of an advertisement on the terminal when the user of the terminal requests to see the advertisement included in the received advertising message, sense movement of the face or the eyes of the user from a video taken by a camera disposed in the terminal in order to ascertain whether the user has seen the displayed contents of the advertisement, determine whether the user has seen the advertisement on the basis of the sensed movement of the face of the eyes of the user and then notifies the advertisement server of the determined result, and include the advertisement into the list of advertisement that the user of the terminal has seen, into the user account of the user of the terminal, when it is ascertained that the user has seen the advertisement.

According to another aspect of the present invention, a method of intermediating an on-line advertisement, which stores on-line advertisements registered through an on-line advertisement intermediation site in a database and allows the on-line advertisements stored in the database to be seen and distributed by a plurality of users see the on-line advertisements through a communication network, by displaying an advertisement list of the stored on-line advertisement on the on-line advertisement intermediation site, includes: (A) providing the contents of an on-line advertisement to a terminal of a user when receiving a request for seeing the on-line advertisement stored in the database; (B) receiving the information for ascertaining whether the user has seen the advertisement provided in the step (A) from the terminal and comparing the information with information stored for the advertisement; (C) registering the advertisement on the account of the user who has seen the advertisement when the two pieces of information compared in the step (B) coincide with each other; and (D) creating and transmitting an advertising message including the advertisement to a terminal of another user, when receiving a request for transmitting the advertisement registered on the account of the user in the step (C) from the terminal to another user.

The method may further include: registering an advertisement on the database, in which the registering of an advertisement may include: receiving on-line advertisement registration information including the contents of the advertisement and the total amount of money of the advertisement from a user; setting the total amount of money of an advertisement; and storing the on-line advertisement with the advertisement registration information in the database and displaying the on-line advertisement with on-line advertisements, which has been registered, on the list of advertisements.

Further, the advertising message may be transmitted by at least one of an email, a text message of a mobile communication terminal, and a message of an instant messenger program.

As described above, according to the system and method for intermediating an on-line advertisement of the present invention, it is possible to expect the following effects.

That is, it is possible to increase the convenience of users and corresponding activate on-line advertisement, by providing a user interface that simplifies the procedures for registering and posting an on-line advertisement.

Further, according to the system and method for intermediating an on-line advertisement of the present invention, it is possible to easily search an on-line advertisement and post the on-line advertisement onto a website, and increase the range of selection of an on-line advertisement for users, by providing the on-line advertisements as the database.

Further, according to the system and method for intermediating an on-line advertisement of the present invention, it is possible to spread an advertisement to a plurality of consumers even though advertisers collect the individual information of consumers in person, by allowing the consumers to distribute the on-line advertisement by themselves to make an advertisement profit.

Further, according to the system and method for intermediating an on-line advertisement of the present invention, it is possible to induce an interest in the contents of and advertisement from consumers, because it is necessary to see the advertisement and to be authenticated, in order to transmit the advertisement to another one.

Further, according to the system and method for intermediating an on-line advertisement of the present invention, it is possible to make consumers concentrate their interest in the advertisement, by allowing any consumer can make a profit from an advertisement rate.

Further, according to the system and method for intermediating an on-line advertisement of the present invention, it is possible to achieve an additional advertisement effect while consumers search advertisements with higher cost units, by making the unit cost different for the same advertisements.

### BRIEF DESCRIPTION OF THE DRAWINGS

FIG. 1 is a block diagram schematically illustrating the configuration of a system for intermediating an advertisement according to an exemplary embodiment of the present invention.

FIG. 2 is a flowchart illustrating in detail a method of registering an on-line advertisement according to an exemplary embodiment of the present invention.

FIG. 3 is an exemplary view of an advertisement registration image on an advertisement intermediation site by the method of registering an on-line advertisement illustrated in FIG. 2.

FIG. 4 is a flowchart illustrating step by step a method of registering an advertisement on an advertisement list on an advertisement intermediation website to a user account in a method of intermediating an advertisement according to an exemplary embodiment of the present invention.

FIG. 5 is a flowchart illustrating step by step a method of registering an advertisement in an advertising message to a user account in a method of intermediating an advertisement according to an exemplary embodiment of the present invention.

FIG. 6 is a view showing an example of an advertising message.

FIG. 7 is a flowchart illustrating step by step a method of transmitting an advertising message in a method of intermediating an advertisement according to an exemplary embodiment of the present invention.

FIG. 8 is an exemplary view of the screen of a terminal when sending an advertising message in the formation of an email in the method illustrated in FIG. 7.

### DETAILED DESCRIPTION OF THE PREFERRED EMBODIMENTS

A system and a method for intermediating an advertisement according to an exemplary embodiment of the present invention are described hereafter in detail with reference to the accompanying drawings.

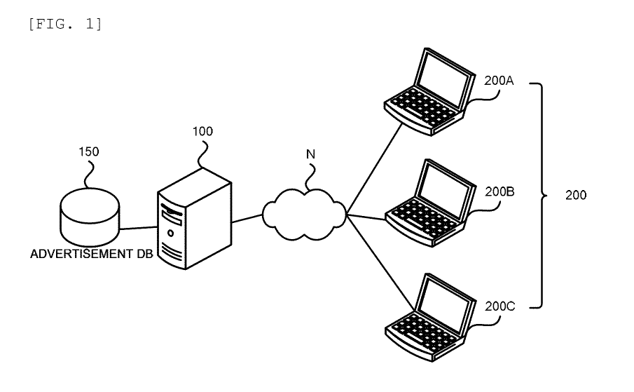

FIG. 1 is a block diagram schematically illustrating the configuration of a system for intermediating an advertisement according to an exemplary embodiment of the present invention.

First, as illustrated in FIG. 1, a system for intermediating an advertisement according to an exemplary embodiment of the present invention includes an advertisement server 100. The advertisement server 100 functions to construct an advertisement database, using various multimedia advertisements registered by a plurality of users, and provide the advertisements accumulated in the advertisement database back to the users. The advertisement server 100 provides an on-line advertisement intermediation site as a virtual space for the function. Accordingly, the users can connect with the advertisement intermediation site and register advertisements, see the registered advertisements, or make a profit by using the registered advertisements.

The advertisement intermediation site provided by the advertisement server 100 is a kind of website, which is a set of webpages including a webpage that allows a plurality of users to simply register advertisements and a webpage that makes advertisements easy by selecting advertisements.

The advertisement server 100 stores the advertisements registered by the users in an advertisement database 150 (hereafter, referred to as an advertisement DB). The advertisement DB 150 classifies and stores advertisements registered by advertisers through the advertisement intermediation site. Data such as images, videos, and audios which constitutes the contents of the advertisements, the advertisers who have registered the advertisements, the kinds of products or services to be advertised, the categories where the products or services pertain, and data relating to the advertisement rates may be included in the data stored in the advertisement DB 150.

Meanwhile, the users are provided with various services that are provided through the advertisement intermediation site by the advertisement server 100, by exchanging data with the advertisement server 100 through a network N such as the Internet, with terminals 200.

The terminals 200 in the exemplary embodiment may be various information processing devices equipped with a communication device such as a personal computer, a PDA, and a mobile terminal. The terminals 200 can connect with the communication network through a wire or wirelessly, such that they can exchange data with the advertisement server 100.

The users can register advertisements through an advertisement intermediation site provided by the advertisement server 100, using the terminals 200, or can make a profit through advertisement rates by selecting the registered advertisements.

The users may select and see some advertisement on the advertisement intermediation site and then may transmit the advertisements back to other users, in order to make a profit by using the advertisements registered on the advertisement intermediation site provided by the advertisement server 100, by using the terminals 200. That is, when seeing a specific advertisement on the advertisement intermediation site, a user can create and transmit an advertising message including the seen advertisement to other users. The user can be allocated with more advertisement rate by transmitting more advertisements to more users through the advertisement intermediation site.

Further, a user receiving the advertising message can also take a profit through an advertisement rate by accessing the advertisement included in the advertising message and then transmitting the advertising message to another user. Such a method is described in detail below.

A method of allowing a plurality of users to use advertisements registered by advertisers using the system for intermediating an advertisement described above is described hereafter with reference to the drawings.

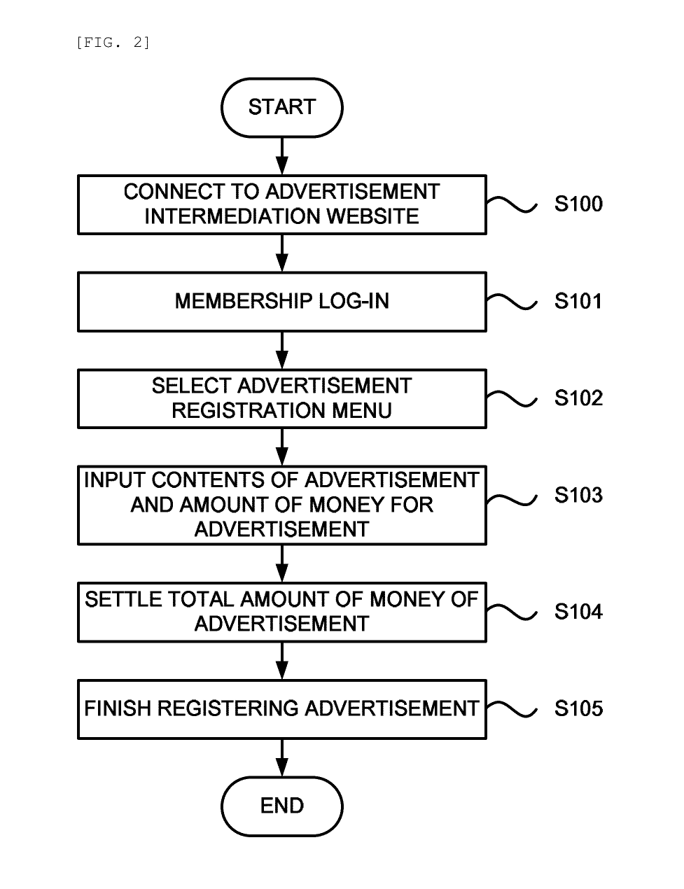

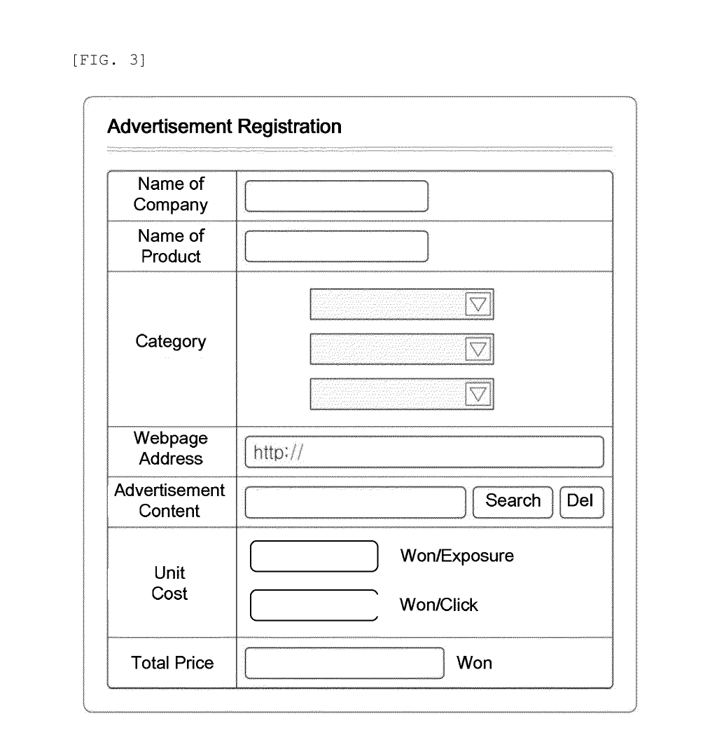

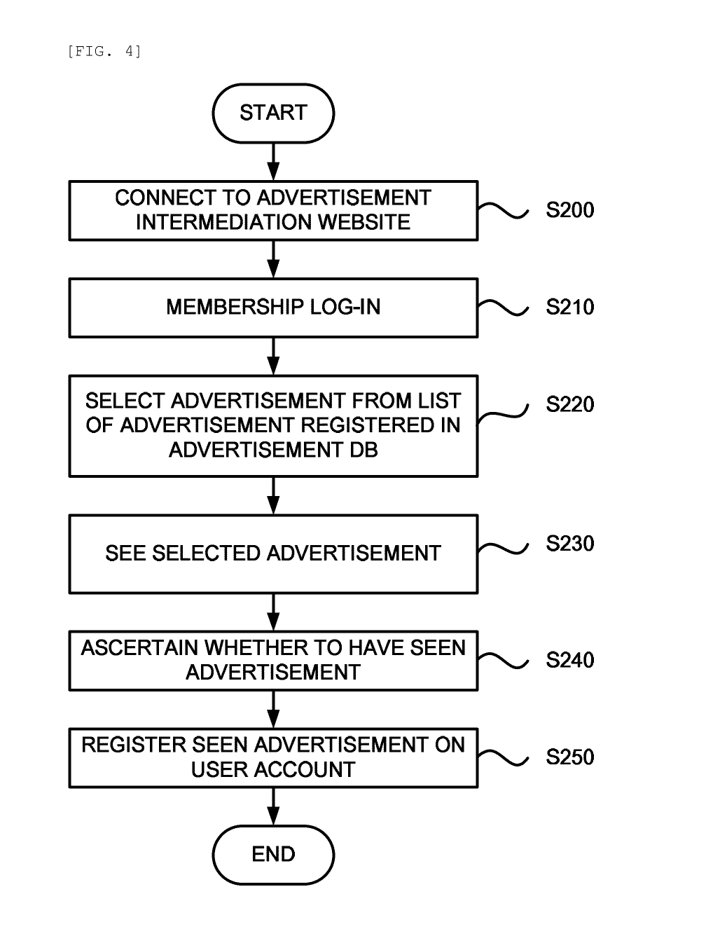

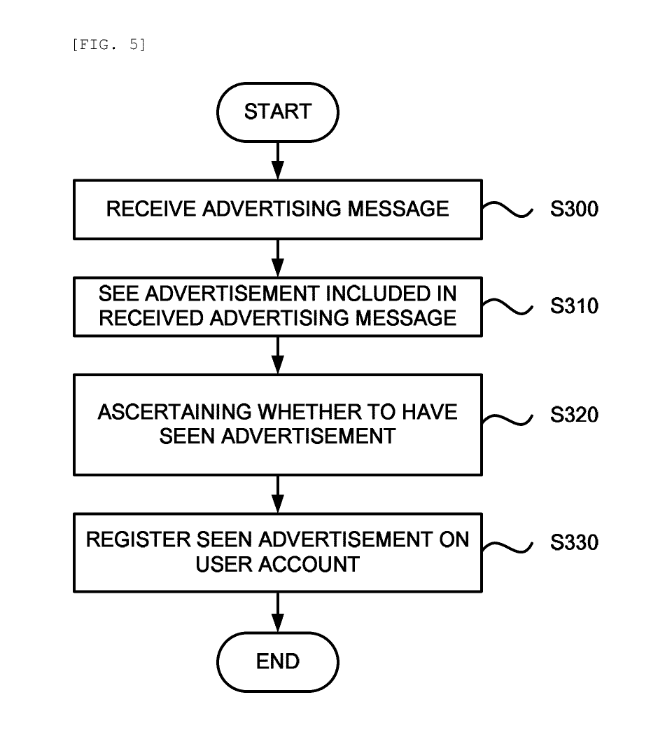

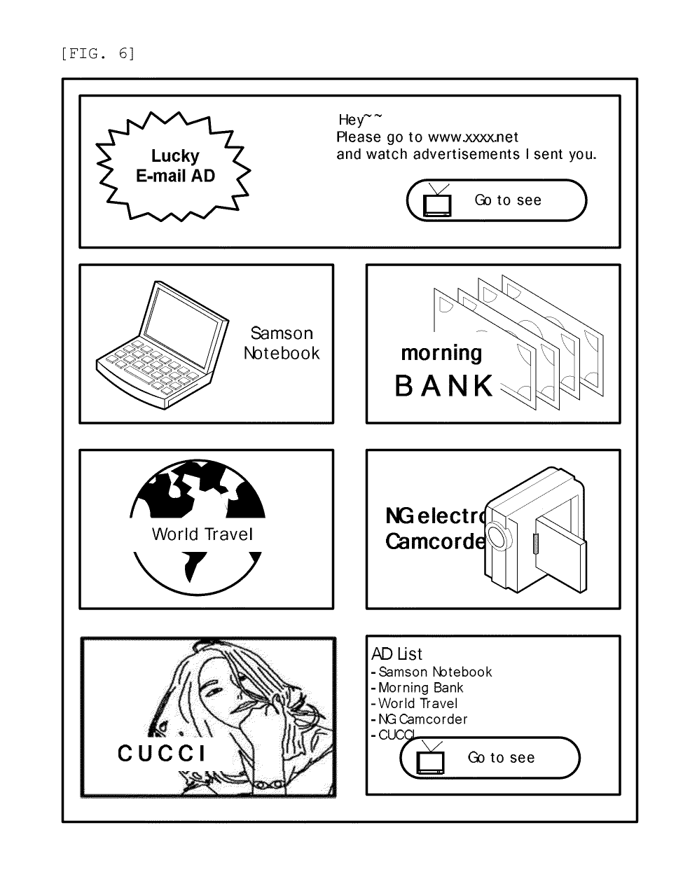

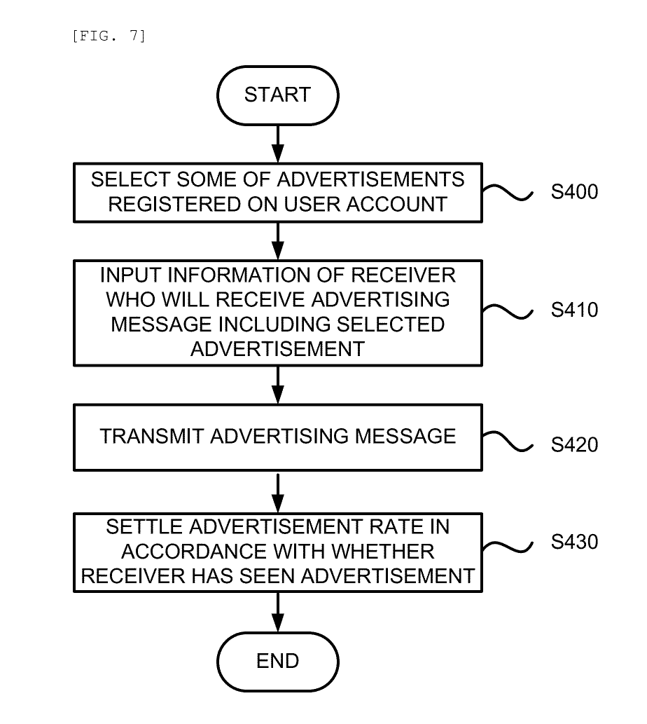

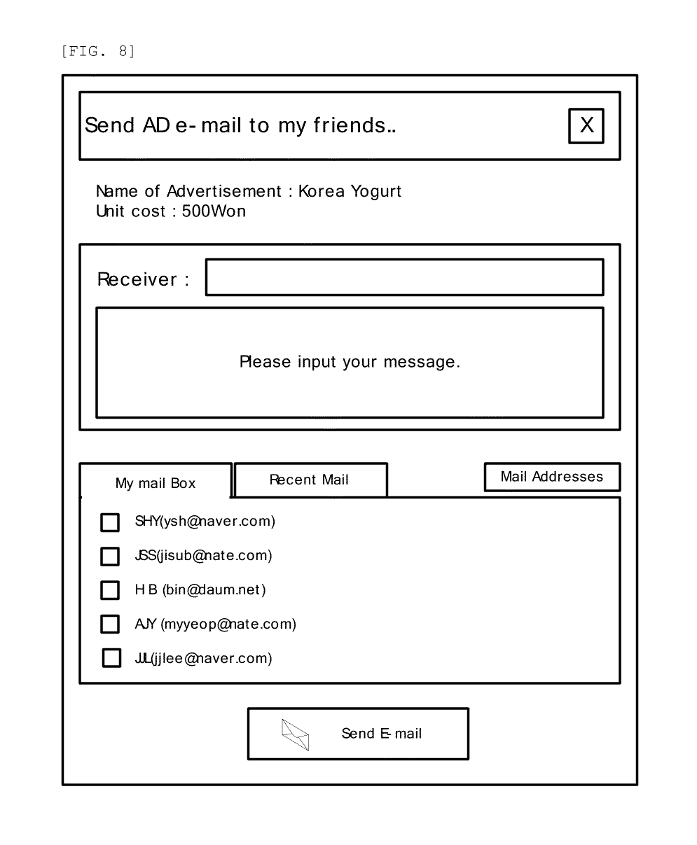

FIG. 2 is a flowchart illustrating in detail a method of registering an on-line advertisement according to an exemplary embodiment of the present invention, FIG. 3 is an exemplary view of an advertisement registration image on an advertisement intermediation site by the method of registering an on-line advertisement illustrated in FIG. 2, FIG. 4 is a flowchart illustrating step by step a method of registering an advertisement in an advertisement list on an advertisement intermediation website to a user account in a method of intermediating an advertisement according to an exemplary embodiment of the present invention, FIG. 5 is a flowchart illustrating step by step a method of registering an advertisement in an advertising message to a user account in a method of intermediating an advertisement according to an exemplary embodiment of the present invention, FIG. 6 is a view showing an example of an advertising message, FIG. 7 is a flowchart illustrating step by step a method of transmitting an advertising message in a method of intermediating an advertisement according to an exemplary embodiment of the present invention, and FIG. 8 is an exemplary view of the screen of a terminal when sending an advertising message in the formation of an email in the method illustrated in FIG. 7.

As illustrated in FIG. 2, a user can register an advertisement in the advertisement DB 150, using the terminal 200, and the procedure is performed first through the advertisement intermediation site provided by the advertisement server 100.

A user connects first with the advertisement intermediation site provided by the advertisement server 100 through the network N, using the terminal 200 (S100). The user connects with the advertisement site by inputting the URL address of the advertisement intermediation site operated by the advertisement server 100 to a web browser and the advertisement server 100 transmits the homepage of the advertisement intermediation site to the terminal 200 in response to the request for connection.

Further, the user logs in to the advertisement intermediation site though authentication to register his/her advertisement into the advertisement DB 150 through the advertisement server 100 (S101). When the user is not a member, the user may follow a membership procedure.

When the user follows the log-in procedure, the advertisement server 100 determines whether the input ID and password are correct by comparing them with information that has been stored in advance, and completes the log-in procedure only when they are correct.

The advertisement server 100 provides an advertisement registration menu on a webpage included in the advertisement intermediation site and provides a webpage through which a user can input the information on the advertisement, which the user wants to register, when the user selects the advertisement registration menu (S102). The information for registering an advertisement may be, for example, the name of the advertisement company or the product to be advertised, the category where the product or the service is included, the contents of the advertisement, the unit cost of the advertisement, or the total price of the advertisement.

As illustrated in FIG. 3, the advertisement server 100 provides a webpage with various blanks for registering an advertisement. In the example, the webpage for registering an advertisement provides blanks for inputting the names of the advertisement company and the product, a section for selecting the category of the product or the service, a blank for inputting the address of the homepage of product to be advertised or the advertisement company, a blank for registering the contents of an advertisement (advertising image or video), and blanks for inputting the unit cost and the total price of an advertisement.

The unit cost of an advertisement is a unit amount of money that is paid to the corresponding user, when another user uses an advertisement registered on the advertisement intermediation site, for example, which may be the amount of money that the corresponding user can receive, when another user sees and then transmits the advertisement to another user, or may be the amount of money that the corresponding user can receive, when it appears that another user sees and transmits the advertisement to another user and the user who has received the advertisement has seen the advertisement. However, this is only an example and the unit cost of an advertisement may be a unit amount of money that is paid in another case different from the example.

Meanwhile, the advertiser does not have to input the unit cost of an advertisement and the unit cost of an advertisement may be fixed by the regulations that have been set on the advertisement intermediation site in advance. That is, the unit costs of an advertisement may be collectively fixed by the regulations that have been set on the advertisement intermediation site. For example, the same unit cost of an advertisement may be fixed for all of advertisements.

Further, when the unit costs of an advertisement are not registered by advertisers, but collectively fixed by the advertisement intermediation site, two or more unit costs of an advertisement may be fixed for one advertisement. For example, the unit cost of an advertisement that is paid when one advertisement is transmitted to different users may be differently fixed to 50 Won and 100 Won. This is described in detail below.

When the information on the advertisement is inputted from a user through the webpage through which various pieces of information relating to the advertisement can be inputted (S103), the advertisement server 100 provides the user with a webpage for the user to decide payment of the total amount of money of the advertisement. Therefore, the user can settle the total amount of money of an advertisement of the advertisement that he/she wants to register (S104). The total amount of money of an advertisement may be settled by a common method that has been used in the existing electronic commercial transaction.

When an advertisement finishes being registered in the advertisement server 100 by settling the total amount of money of an advertisement (S105), the advertisement server 100 stores the advertisement and relating data to the advertisement DB 150 and displays the advertisement on the advertisement intermediation site such that other users can see it. The advertisement server 100 may post a plurality of advertisement lists registered as described above, on the advertisement intermediation site and may provide a search service such that users can search desired advertisements, using the name of the category of the advertised products.

Meanwhile, when an advertisement database is constructed in the advertisement DB 150 by advertisements registered in the advertisement server 100 through the advertisement intermediation site by users, as described above, other users can come into action for making a profit, using the advertisements. For this operation, the advertisement server 100 provides a service that allows users to transmit/receive advertising services to/from each other.

A method for a user to register an advertisement onto his/her account to transmit/receive an advertising message and a method of transmitting an advertising message by using the advertisement registered on the user account are described in detail hereafter.

First, as illustrated in FIG. 4, users can transmit an advertising message by connecting with the advertisement intermediation site with the terminal 200. That is, when a user connects with the advertisement intermediation site (S200), logs in through authentication (S210), and selects any one of a plurality of advertisements included in an advertisement list provided by the advertisement intermediation site (S220), the advertisement server 100 provides the contents of the selected advertisement to the terminal 200 such that the user can see the contents of the advertisement (S230). The advertisement may be an advertisement including video contents.

The advertisement server 100 may provide various pieces of information about the selected advertisement. For example, the information on the unit cost of an advertisement, the information on the advertiser who provides the advertisement, and the information on the product or the service to be advertised may be provided.

Meanwhile, a process of ascertaining whether a user has seen an advertisement after the contents of the advertisement is provided to the user may be performed (S240).

Step S240 may be performed in various ways. Specific information is displayed for a predetermined time in the entire running time of advertisement video contents, and then the corresponding information can be ascertained by being inputted in the formation of text. For example, when the information on the unit cost of an advertisement is included in video contents and provided to a user and then the user input again the displayed unit cost of an advertisement as it is, it can be considered that the advertisement has been seen. Alternatively, when specific voice information is inserted into audio data and outputted and then the information is inputted from a user and coincides with the output information, it can be considered that the advertisement has been seen. Further, it is possible to consider that an advertisement has been seen, in an image or text advertisement, by inquiring specific information included in an image or a text and by inputting the correct answer for the inquiry. As described above, step S240 is performed in order to maximize the advertisement effect by increasing the user's concentration on the advertisement.

Further, a method of using a camera disposed on the display screen of the terminal 200 may be used to ascertain whether a user has seen an advertisement in step S240. That is, step S240 may be performed by photographing movement of the face or the eyes of the user of the terminal 200 with the camera of the terminal 200 while an advertisement is displayed on the terminal 200, and by watching whether the user's face or eyes have been fixed to the display screen over a predetermined time. For this operation, the advertisement server 100 can provide an application that observes the movement of the user's face of eyes through the camera while an advertisement is displayed on the terminal 200 and provides the result to the advertisement server 100. As described above, when whether an advertisement has been seen is ascertained by observing the user's face or eyes, it is not necessary to ascertain whether specific information inserted in the advertisement coincides with input information by receiving a text from the user.

On the other hand, the information about the advertisement which can be provided with the contents of the advertisement may be exposed to the user only after step S240.

The advertisement that the user has seen is registered on the list of advertisements that the user has seen (S250). That is, the advertisement is registered on the user's account. Therefore, the user can transmit an advertising message, using the advertisements registered on his/her account. That is, the present invention has the advantage that it is possible to not only transmit an advertisement to many users, but make many users concentrate on the contents of the advertisement, by allowing the advertisements that the users have seen to be transmitted to others.

Meanwhile, the users may check the unit costs of the advertisements registered on their accounts, in which the unit costs of advertisements may be the amount of money inputted with registration by the advertisers or may be the amount of money determined by the advertisement server 100.

Further, as described above, when the unit cost of an advertisement is fixed by the advertisement server 100, two or more different unit costs may be fixed for one on-line advertisement, in detail, when various users see the advertisements on the on-line advertisement list of the advertisement intermediation site, it is possible to determine different unit costs of corresponding advertisements and output the unit costs in accordance with frequency of a predetermined ratio. For example, when one advertisement is selected by a user and the unit cost of the selected advertisement is displayed, the predetermined unit cost of an advertisement may be randomly displayed by any one of 50 Won, 70 Won, and 100 Won, in which the unit costs of an advertisement of 50 Won, 70 Won, and 100 Won may be displayed by predetermined ratios, that is, probability of 60%, 30%, and 10%. That is, the unit cost of an advertisement may be displayed as 50 Won for 60% of the users who have selected the same advertisement, 70 Won for 30%, and 100 Won for the rest 10%.

It is possible to keep displaying the same amount of money even if one user sees the corresponding advertisement again and checks the unit cost of the advertisement for a predetermined time, for example, for a week. Further, when the user transmits the on-line advertisement to another user, the advertisement rate is determined by the unit cost of an advertisement that is the amount of money that has been displayed to the user.

As described above, when the unit costs of an advertisement are made different, the unit costs of an advertisement are displayed after advertisements are see, and only the same amount of unit cost of an advertisement is displayed for a predetermined time for the same advertisement to the users, a user who wants to make an advertisement profit by selecting and transmitting a specific advertisement to another user through the advertisement intermediation site sees more advertisements to select an advertisement with a higher unit cost on the on-line advertisement list of the advertisement intermediation site.

That is, for example, when one advertisement is seen and it is ascertained that the unit cost of the advertisement is 50 Won, the user sees many advertisements until finding an advertisement with the unit cost of 100 Won without transmitting the advertisement to another user in order to make a higher advertisement profit by selecting an advertisement with a higher unit cost. Therefore, when different unit costs are fixed for advertisements, as described above, there is an advantage that the advertisement effect is large, for the advertisers who have post the advertisement on the advertisement intermediation site, because the users see many advertisements before transmitting the advertisement to others, and the users who want make a profit by transmitting the advertisement to others also have an advantage because they can obtain a large advertisement profit by selecting appropriate advertisements.

Meanwhile, the users may see and transmit an advertisement by themselves even without connecting with the advertisement intermediation site, which can be implemented by receiving an advertising message including the contents of an advertisement from another user, as illustrated in FIG. 5.

That is, when a user receives an advertising message from another user (S300), the user can see the advertisement included in the received advertising message (S310).

The advertising message may be transmitted in various ways. The advertising message may be transmitted by an email or the text message service of a mobile terminal. Further, the advertising message may be transmitted in the type of a message using an instant messenger program.

The advertising message may include the information on the transmitter of the advertising message, a text message of the transmitter, and the contents of the advertisement, as illustrated in FIG. 6. Further, one or more advertisements may be included in one advertising message.

When the user who has received an advertising message sees the advertisement included in the advertising message (S310), it is ascertained whether the advertisement has been seen by the user (S320), and the advertisement is registered on the user account of the user who received the advertising message (S330).

Step S320 may be performed in the same way as in step S240 described with reference to FIG. 4.

The method of allowing the user who has received the advertising message by an email, a text message of a mobile terminal, or a message of an instant messenger to see the advertising message may be implemented in a way that when the advertisement included in the advertising message is selected and there is request for seeing the advertisement, a log-in image for connecting with the advertisement intermediation site provided by the advertisement server 100 is outputted, and when the user logs in to the advertisement intermediation site, the contents of the advertisement is outputted, whether the user has seen the advertisement is ascertained, and then the advertisement is registered on the user account of the advertisement intermediation site.

However, the method is not necessarily performed by the steps described above, and for example, when a user opens the received advertising message, the contents of the advertisement are all directly shown in the advertising message and the user can input the information, which has been inserted in the contents of the advertisement, for ascertaining whether the advertisement has been seen can in accordance with the displayed contents of the advertisement. When the input information is transmitted to the advertisement server 100 from the terminal 200, the advertisement server 100 determines whether the input information coincides with the information for ascertaining whether the advertisement has been seen. Further, when the user transmits the advertising message to another user, the advertisement server 100 allows the contents of the advertisement to be shown in the advertising message of the receiver who has received the advertising message, only when it has been ascertained that the transmitter of the advertising message has seen the advertisement, when displaying the advertisement in the advertising message transmitted to the another user.

That is, the contents of the advertisement in the advertising message is displayed on the terminal 200, as the data stored in the advertisement DB 150 is transmitted in real time to the terminal 200; however, it is possible to prevent the contents of the advertisement from being transmitted to the terminal 200 of the receiver from the advertisement DB 150, unless it has been ascertained that the transmitter of the advertising message has seen the advertisement in the advertising message. As described above, this is for transmitting the advertisement to another user only when the user has seen the advertisement.

A process that a specific user transmits an advertisement registered on the user account of the user in the advertisement intermediation site to another user is described hereafter.

A user selects some of the advertisements registered on his/her user account on the advertisement intermediation site (S400). The advertisement server 100 provides a service for transmitting the advertisements registered on the his/her user account, that is, the advertisement registered on the advertisement list that the user has seen, with an advertising message to another user, and for this service, the user selects at least one of the advertisements registered on the his/her user account.

Further, the information on the receiver who will receive the advertising message including the selected advertisement is inputted (S410). The receiver information may be an email address when the advertising message is transmitted by an email, may be the number of a mobile communication terminal when it is transmitted by a text message of a mobile terminal, or may be the ID of the user registered on a server that provides a messenger program when it is transmitted by a message of an instant messenger program.

Further, it may be possible to follow a procedure of inputting a text message to be included in the advertising message, before transmitting the advertising message.

That is, as illustrated in FIG. 8, the user inputs a text message and transmits an advertising message by inputting the receiver information, after selecting an advertisement (S420).

Further, the user who has transmitted the advertising message receives the advertisement rate in accordance with the result of transmitting the advertising message (S430). It may be possible to receive the bank account information of the user from the user in advance to settle the advertisement rate for the user.

The advertisement rate may be settled in a way of settling a predetermined unit cost of an advertisement, when one advertisement has been transmitted to another one.

It may be possible to pay the advertisement rate to the user from the advertisement server 100 on the basis of only the fact that the user has transmitted the advertising message, to pay the unit cost of the advertisement that has been seen, only when another user, who has received the advertising message transmitted by the user, has seen the advertisement by ascertaining whether to have seen the advertisement, or to pay the advertisement rate to the user, only when another user, who has received the advertising message transmitted by the user, has seen the advertisement included in the advertising message and then transmitted the advertising message to another user.

On the other hand, the advertisement rate is not necessarily paid by cash and may be paid by marketable securities such as various points. Further, the users may collect the point due to the profit from the advertisement rates and settle the points for the total amount of money of an advertisement when registering his/her advertisements.

In order to perform a series of the processes, the advertisement server 100 makes the list of advertisements, which users have seen, be stored in the user account of the users, by separately storing the information on the advertisements that the users have seen, for the users, respectively. Further, when the users select a specific advertisement from their user accounts, a webpage through which the users can receive the receiver information is provided such that the users can transmit an advertising message, using the advertisement. Further, when a user wants to transmit an advertising message, the advertisement server 100 creates and transmits an email, a text message of a mobile communication terminal, or a message of an instant messenger program to a receiver, in which at least some of the contents of the selected advertisement and a message inputted by the transmitter may be included in the advertising message, and when all of the contents of the selected advertisement are not shown in the advertising message, a hypertext or a hyperimage for showing all of the contents of the advertisement and a hypertext or a hyperimage for liking to the advertisement intermediation site may be included.

For example, as illustrated in FIG. 6, only still images of a video advertisement may be included in the advertising message, and the still images may become hyperimages that allow the entire video advertisement to be displayed, when one of the still images is selected from the advertising message displayed on the terminal 200.

That is, when a user selects an advertisement and transmits an advertising message to another user, the advertisement server 100 creates and transmits an advertising message including a hyperimage for linking to the URL address where all of the contents of the selected advertisement are displayed.

The advertisement server 100 may create an advertising message such that the contents of the advertisement are displayed after the user has logged in to the advertisement intermediation site, without directly linking to the URL address where all of the contents of any one advertisement in at least one or more advertisements included in the advertising message are displayed. For example, as illustrated in FIG. 6, when an icon of ‘go to see advertisement’ is selected from an advertising message, a webpage including a log-in image for the advertisement intermediation site is linked first, and when log-in is finished, the contents of the advertisement included in the advertising message may be linked.

When the advertising message is transmitted to another user, another user who has received the advertising message may see the advertisement included in the advertising message and then transmit an advertising message including the seen advertisement to another user.

The advertisement server 100 that operates the advertisement intermediation site pays the advertisement rate calculated on the basis of the unit cost of an advertisement to the users, by watching transmission of advertising messages and whether the users see the advertisements included in the transmitted advertising message.

When the total amount of money of advertisement that has been settled when the advertiser who has registered a specific advertisement registers the advertisement is exhausted, the advertisement may be deleted from the advertisement list on the advertisement intermediation site or the user accounts, or an advertising message including the advertisement may be prevented from being transmitted.

On the other hand, the unit costs of advertisements are not necessarily uniform, as described above, may be displayed to be different for the users, and accordingly, the advertisement rates may be calculated in accordance with the unit cost of an advertisement for each user when the advertisement rates are calculated. For example, when a user A sees an advertisement X, the unit cost of an advertisement displayed for the user A may be 10 Won, and when the user A transmits the advertisement X by an advertising message to a user B and the user B sees the advertisement X, the unit cost of the advertisement may be displayed by 20 Won. When the user B transmits the advertisement X by an advertising message to a user C, the user A receives 10 Won by transmitting an advertising message to the user B, while the user B can receive 20 Won by transmitting an advertising message to the user C.

Meanwhile, as described above, an advertising messenger program may be used as the application for transmitting/receiving an advertising message in the exemplary embodiment of the present invention. The advertising messenger program functions to transmit/receive an advertising message by operating with the advertisement server 100, when being installed in the terminal 200.

That is, the advertising messenger program may be logged in by user's ID and password, similar to common instant messenger programs, and a user information list of other users who the user knows is stored in the user accounts in the advertisement server 100. Further, the lists of advertisement that the users have seen are stored in the user accounts, respectively.

When a transmitter transmits an advertising message by operating with the advertisement server 100, the advertising messenger program transmits the advertising message to a receiver, and the receiver is notified the fact that the advertising message has been transmitted. Further, when the receiver wants to see the advertisement included in the advertising message, the advertising messenger program receives the contents of the advertisement from the advertisement server 100 and displays the contents by transmitting the request to the advertisement server 100.

Further, the advertisement server 100 may separately store the specifications of paying advertisement rates to the users and the specifications of transmitting/receiving advertising messages, and provide the users with the specifications through the advertising messenger program.

The present invention is not limited to the exemplary embodiments described above and defined by claims, and it is apparent to those skilled in the art that the present invention may be modified in various ways without departing from the scope of the present invention described in claims.

1. A system for intermediating an on-line advertisement that provides an on-line advertisement intermediation site to a plurality of terminals connected through a communication network, the system comprising:
a database where a plurality of on-line advertisements is stored; and
an advertisement server that provides an advertisement list of the on-line advertisements stored in the database to the terminals, that when receiving a request for seeing some of the advertisements included in the advertisement list from users, displays the contents of the advertisements on the terminals, ascertains whether the users have seen the advertisements, and stores lists of the advertisements that the users have seen, to user accounts, respectively, creates an advertising message including at least one of the advertisements included in the lists of the advertisements stored in the user accounts and transmits the advertising message to the terminals of another user, in accordance with an instruction from the user.

2. The system of claim 1, wherein the advertisement server provides a user interface for receiving on-line advertisement registration information from the terminal and registering the on-line advertisement to the terminal, registers the advertisement on the advertisement list by processing the on-line advertisement registration information inputted from the terminal and determining whether to register the on-line advertisement, and stores the on-line advertisement registration information in the database.

3. The system of claim 1, wherein the advertisement server, when receiving a request for seeing any one advertisement in the advertisement list of the on-line advertisements stored in the database, from the terminal, outputs the advertisement with predetermined information including a text or audio data to the terminal, and considers that a user has seen the advertisement, includes the advertisement into the list of the seen advertisements, and stores the advertisement in the user account, only when information inputted from the terminal coincides with the predetermined information.

4. The system of claim 1, wherein the advertisement server provides the terminal with an application for ascertaining whether a user has seen an advertisement by photographing the face or the eyes of the user of the terminal while the advertisement is displayed on the terminal, and
when receiving a request for seeing any one advertisement in the advertisement list of the on-line advertisement stored in the database from the terminal, outputs the advertisement to be displayed on the terminal, receives the result of executing the application from the terminal, and then includes the advertisement into the list of the seen advertisements and stores the advertisement in the user account, only when it is ascertained that the user has seen the advertisement.

5. The system of claim 1, wherein the advertising message includes a hypertext or a hyperimage for connecting with an URL address of a webpage including the information on the user who transmits the advertising message, advertisement information included in the advertising message, and the contents of the advertisement included in the advertising message.

6. The system of claim 1, wherein the advertising message is transmitted by at least one of an email, a text message of a mobile communication terminal, and a message of an instant messenger program.

7. The system of claim 3, wherein the advertisement server calculates the unit cost of the advertisement included in the advertising message as an advertisement rate to be paid to a user, when the advertising message is transmitted, the terminal of another use to which the advertising message is transmitted requests for transmitting a webpage including the contents of the transmitted advertisement in the advertising message, information inputted from the terminal of another user coincides with predetermined information including a text or audio data included in the contents of the advertisement after the terminal of the another user to which the advertising message is transmitted requests for transmitting the webpage including the contents of the transmitted advertisement in the advertising message.

8. The system of claim 3, wherein the advertisement server, when displaying the information on the unit cost of an advertisement after a user sees the advertisement on the terminal, displays any one of two or more different unit costs of an advertisement that is set to have different ratios of exposure frequency on the terminal, and calculates an advertisement rate on the basis of the unit cost of an advertisement displayed on the terminal, when calculating the advertisement rate according to the result of transmitting an advertising message to the terminal of another user from the user of the advertisement.

9. The system of claim 8, wherein the two or more different unit costs of an advertisement are set to have an exposure frequency with a ratio that increases with a decrease of the unit cost of an advertisement.

10. A storage medium where an advertisement messenger program, which stores on-line advertisements registered through an on-line advertisement intermediation site in a database and operates with an advertisement server that allows the on-line advertisements stored in the database to be distributed and seen to a plurality of users through a communication network, by displaying an advertisement list of the stored on-line advertisement on the on-line advertisement intermediation site, wherein the advertisement messenger program, when being installed in a terminal,
(A) provides a list of friends of a user of the terminal and a list of advertisements that the user of the terminal has seen, in accordance with the contents stored in a user account in the advertisement server by connecting with the advertisement server when the user of the terminal logs in,
(B) when an advertising message transmitted by another user is received by the advertisement server, displays the received advertising message to the terminal, and
(C) when the user of the terminal selects at least one advertisement from the list of advertisement that the user has seen, selects at least one friend from the friend list, and gives an instruction of transmitting an advertising message, notifies the advertisement server of the selected information.

11. The storage medium of claim 10, wherein the advertisement messenger program provides a record of transmitting/receiving an advertising messenger of the user of the terminal and provides the result of calculating an advertisement rate that is paid to the user of the terminal.

12. The storage medium of claim 10, wherein the advertisement messenger program displays the contents of an advertisement when the user of the terminal requests to see the advertisement included in the received advertising message to the terminal,
receives the information for ascertaining whether the user has seen the displayed contents of the advertisement and provides the information to the advertisement server, and
includes the advertisement into the user account of the user of the terminal and into the list of advertisements that the user of the terminal has seen, when the input information coincides with information that is stored in advance for the advertisement in the advertisement server.

13. The storage medium of claim 10, wherein the advertisement messenger program displays the contents of an advertisement on the terminal when the user of the terminal requests to see the advertisement included in the received advertising message,
senses movement of the face or the eyes of the user from a video taken by a camera disposed in the terminal in order to ascertain whether the user has seen the displayed contents of the advertisement,
determines whether the user has seen the advertisement on the basis of the sensed movement of the face of the eyes of the user and then notifies the advertisement server of the determined result, and
includes the advertisement into the list of advertisement that the user of the terminal has seen, into the user account of the user of the terminal, when it is ascertained that the user has seen the advertisement.

14. A method of intermediating an on-line advertisement, which stores on-line advertisements registered through an on-line advertisement intermediation site in a database and allows the on-line advertisements stored in the database to be seen and distributed by a plurality of users see the on-line advertisements through a communication network, by displaying an advertisement list of the stored on-line advertisement on the on-line advertisement intermediation site, the method comprising:
(A) providing the contents of an on-line advertisement to a terminal of a user when receiving a request for seeing the on-line advertisement stored in the database;
(B) receiving the information for ascertaining whether the user has seen the advertisement provided in the step (A) from the terminal and comparing the information with information stored for the advertisement;
(C) registering the advertisement on the account of the user who has seen the advertisement when the two pieces of information compared in the step (B) coincide with each other; and
(D) creating and transmitting an advertising message including the advertisement to a terminal of another user, when receiving a request for transmitting the advertisement registered on the account of the user in the step (C) from the terminal to another user.

15. The method of claim 14, further comprising: registering an advertisement on the database,
wherein the registering of an advertisement includes:
receiving on-line advertisement registration information including the contents of the advertisement and the total amount of money of the advertisement from a user;
setting the total amount of money of an advertisement; and
storing the on-line advertisement with the advertisement registration information in the database and displaying the on-line advertisement with on-line advertisements, which has been registered, on the list of advertisements.

16. The method of claim 14, wherein the advertising message is transmitted by at least one of an email, a text message of a mobile communication terminal, and a message of an instant messenger program.
